(19) United States
(12) Patent Application Publication
(10) Pub. No.: US 2022/0406289 A1
(43) Pub. Date: Dec. 22, 2022

(54) DETECTION APPARATUS, METHOD AND PROGRAM FOR THE SAME

(71) Applicant: NIPPON TELEGRAPH AND TELEPHONE CORPORATION, Tokyo (JP)

(72) Inventors: Hiroki KANAGAWA, Tokyo (JP); Yusuke IJIMA, Tokyo (JP)

(73) Assignee: NIPPON TELEGRAPH AND TELEPHONE CORPORATION, Tokyo (JP)

(21) Appl. No.: 17/779,172

(22) PCT Filed: Nov. 25, 2019
(86) PCT No.: PCT/JP2019/046016

§ 371 Date: May 24, 2022

(51) Int. Cl. G10L 13/06; G10L 15/04; G10L 25/87

(52) U.S. Cl. CPC G10L 13/06; G10L 15/04; G10L 25/87

(57) ABSTRACT

A detection device includes a labeling acoustic feature calculation unit configured to calculate a labeling acoustic feature from voice data, a time information acquisition unit configured to acquire a label with time information corresponding to the voice data from a label with no time information corresponding to the voice data and the labeling acoustic feature through a use of a labeling acoustic model configured to receive, as inputs, a label with no time information and a labeling acoustic feature and output a label with time information, an acoustic feature prediction unit configured to predict an acoustic feature corresponding to the label with time information and acquire a predicted value through a use of an acoustic model configured to receive, as an input, a label with time information and output an acoustic feature, an acoustic feature calculation unit configured to calculate an acoustic feature from the voice data, a difference calculation unit configured to determine an acoustic difference between the acoustic feature and the predicted value, and a detection unit configured to detect a labeling error on a basis of a relationship regarding which of the difference and a predetermined threshold value is larger or smaller than the other.

### TECHNICAL FIELD

The present invention relates to a detection device for detecting a labeling error that is caused when giving time information to a phoneme label corresponding to voice data, a method of the same, and a program.

### BACKGROUND ART

To construct an acoustic model of a voice synthesis, voice data and a phoneme label (hereinafter referred to simply as “label”) corresponding to the voice data are required. In deep learning-based voice synthesis, which is the mainstream of statistical parametric voice synthesis in recent years, time information must be given accurately in order to map frame-level linguistic and acoustic features between inputs and outputs of the model. The processing of giving time information to phonemes is called phoneme labeling, and it requires a great deal of time and cost to perform this phoneme labeling manually, since it requires listening to the voice data many times while matching the labels with the voice data.

Hidden Markov models (HMMs) are often used as a method to automatically perform this phoneme labeling (see PTL 1 and NPTL 1). By giving acoustic features and phoneme labels to the HMM, labels with time information can be obtained through a search algorithm. In the related art, the use of Gaussian mixture models (GMMs) for acoustic likelihood calculation has been the mainstream, but in recent years, the methods using deep neural networks (DNNs), which have higher discriminability than GMMs, have become the mainstream (see NPTLs 2 and 3).

Now, consider the case where an automatic labeling model is learned using an approach of using a combination of DNN and HMM (DNN-HMM). In a certain speech, when the acoustic feature series extracted from the voice data is o=[o₁, . . . o_{T}] and the state ID series of the HMM corresponding to the acoustic feature series o is s=[s₁, . . . , s_{T}], the DNN is generally learned to minimize the following cross-entropy.

Loss(o, s)=−xent(o, s)

Here, Sₜ, which is the state ID of the HMM at time t, takes one of the values j=1, . . . , N. However,t=1, 2, . . . , T, and N represents the total number of state types included in the HMM. In order to predict phoneme labels with time information from acoustic feature series and phoneme labels, a user first obtains the posterior probability p(j|oₜ) that the state ID of the HMM is j when the acoustic feature oₜ is given by the forward propagation operation of DNN. By dividing this by the prior probability p(j), an acoustic likelihood p(oₜ|j)=p(j|oₜ)/p(j) is obtained. By inputting the posterior probability series, which is calculated over all states of j=1, . . . , N and all times of t=1, 2, . . . , T, into the HMM, labels with time information can be predicted by the Viterbi algorithm. The prior probability p(j) can be calculated from the frequency of the state IDs appearing in the learning data.

### CITATION LIST

### Patent Literature

PTL 1: Japanese Patent Application Laid-Open No. 2004-077901

### Non Patent Literature

NPTL 1: Hisashi Kawai, Tomoki Toda, “An evaluation of automatic phoneme segmentation for concatenative speech synthesis”, IEICE Technical Report, SP2002-170, pp 5-10, 2003
NPTL 2: G. Hinton, L. Deng, D. Yu, G. Dahl, A. Mohamed, N. Jaitly, A. Senior, V. Vanhoucke, P. Nguyen, T. Sainath, and B. Kingsbury, “Deep neural networks for acoustic modeling in speech recognition,” IEEE Signal Processing Magazine, Vol. 29 (6), pp. 82-97, 2012.
NPTL 3: David Ayllon, Fernando Villavicencio, Pierre Lanchantin, “A Strategy for Improved Phone-Level Lyrics-to-Audio Alignment for Speech-to-Singing Synthesis”, Proc. Interspeech, pp. 2603-2607

### SUMMARY OF THE INVENTION

### Technical Problem

However, in the labels with time information obtained by automatic labeling including the above-described framework, phoneme boundaries may be far different from those of the labels with time information obtained by manual labeling. If such labels with time information far different from those obtained by manual labeling are used for learning the acoustic model used in voice synthesis, sentences corresponding to the labels with time information far different from those obtained by manual labeling are voice-synthesized, and a voice in which different phonemes are uttered at unintended times are synthesized. In order to prevent this, it is preferable to manually correct the phoneme boundary positions in the automatic labeling results, but as described above, this task is extremely time-consuming and costly to perform manually.

An object of the present invention is to provide a detection device for automatically detecting erroneous automatic phoneme labeling, a method of the same, and a program.

### Means for Solving the Problem

To solve the above-mentioned problems, a detection device according to an aspect of the present invention includes a labeling acoustic feature calculation unit configured to calculate a labeling acoustic feature from voice data, a time information acquisition unit configured to acquire a label with time information corresponding to the voice data from a label with no time information corresponding to the voice data and the labeling acoustic feature through a use of a labeling acoustic model configured to receive, as inputs, a label with no time information and a labeling acoustic feature and output a label with time information, an acoustic feature prediction unit configured to predict an acoustic feature corresponding to the label with time information and acquire a predicted value through a use of an acoustic model configured to receive, as an input, a label with time information and output an acoustic feature, an acoustic feature calculation unit configured to calculate an acoustic feature from the voice data, a difference calculation unit configured to determine an acoustic difference between the acoustic feature and the predicted value, and a detection unit configured to detect a labeling error on a basis of a relationship regarding which of the difference and a predetermined threshold value is larger or smaller than the other.

### Effects of the Invention

The present invention achieves an effect of automatically detecting erroneous automatic phoneme labeling.

As mentioned above, phoneme labels obtained by automatic phoneme labeling may contain labeling errors, so it is common to manually check the phoneme boundaries of all speeches and manually correct any labeling errors. With the present invention, it is only necessary to manually correct the ones detected as labeling errors, and thus the time and cost of phoneme labeling can be reduced.

### BRIEF DESCRIPTION OF DRAWINGS

FIG. 1 is a functional block diagram of a detection device according to a first embodiment.

FIG. 2 is a diagram illustrating an example of a flowchart of processing of the detection device according to the first embodiment.

FIG. 3 is a diagram illustrating an example of a flowchart of processing of a detection unit according to the first embodiment.

FIG. 4 is a diagram illustrating an example of a flowchart of processing of the detection unit according to the first embodiment.

FIG. 5 is a functional block diagram of a detection device according to a second embodiment.

FIG. 6 is a diagram illustrating an example of a flowchart of processing of the detection device according to the second embodiment.

FIG. 7 is a functional block diagram of a detection device according to a third embodiment.

FIG. 8 is a diagram illustrating an example of a flowchart of processing of the detection device according to the third embodiment.

FIG. 9 is a diagram illustrating an exemplary configuration of a computer to which the present method is applied.

### DESCRIPTION OF EMBODIMENTS

Embodiments of the present invention are described below. Note that in the drawings used for the following description, the components with the same functions and the steps for the same processing operations are denoted with the same reference numerals, and the overlapping description is omitted.

### Point of First Embodiment

A detection device of the present embodiment automatically detects labeling errors that are fatal to voice synthesis when constructing a model for voice synthesis from a result of automatic phoneme labeling. This model for voice synthesis is an acoustic model receiving, as an input, a phoneme label with time information and outputting an acoustic feature or voice data corresponding to the phoneme label. Voice synthesis can be performed based on the output acoustic feature or voice data. The model for voice synthesis can be learned using an acoustic feature obtained from voice data for learning and a corresponding phoneme label with time information for learning, for example. When a phoneme label with time information for learning is acquired by performing phoneme automatic labeling on voice data for learning, labeling errors may be caused as described above, but the detection device of the embodiment detects such labeling errors. Examples of the time information can include (i) information composed of the start time and end time of a phoneme, (ii) information composed of the start time and duration time of a phoneme, and (iii) phoneme information attached to each frame. In the case of (iii), the start time, end time, duration and the like of the phoneme are determined from the frame number, frame length, shift length and the like.

To be more specific, in a case where frame-wise DNN voice synthesis is used in a voice synthesis unit, an acoustic feature for voice synthesis is predicted by inputting a label with time information to an acoustic model for voice synthesis learned using phoneme labels to which phoneme boundaries are clearly given. The acoustic difference (such as a spectrum distance and an F0 error) between the acoustic feature predicted here and an acoustic feature calculated from labeling target voice data is calculated. Note that the labeling target voice data is, in other words, voice data for learning that is used when an acoustic model for voice synthesis is learned. When there is a labeling error that is fatal to voice synthesis, the acoustic difference between the synthesized voice and the original voice tends to be large, and thus, in view of this, fatal labeling errors are detected.

### First Embodiment

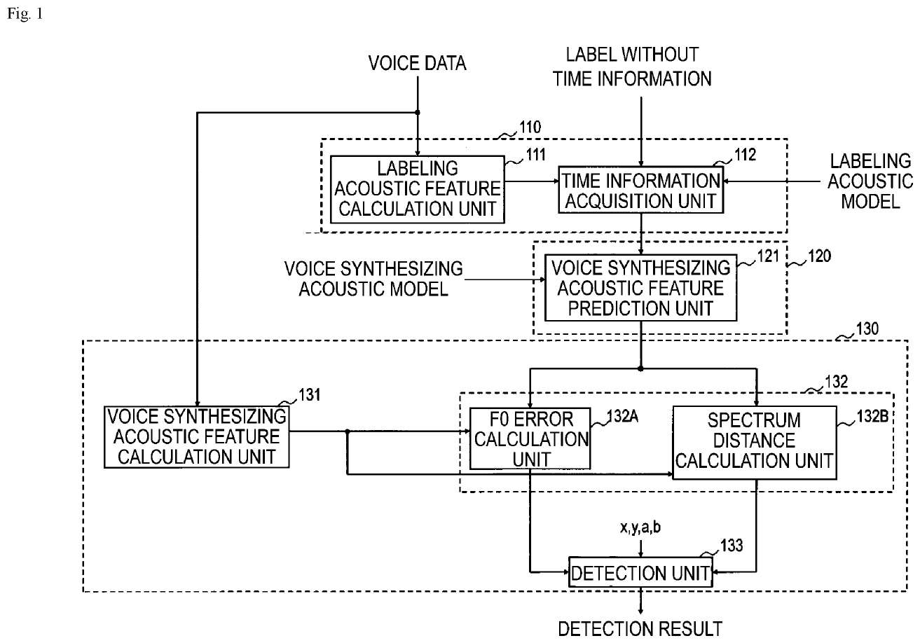

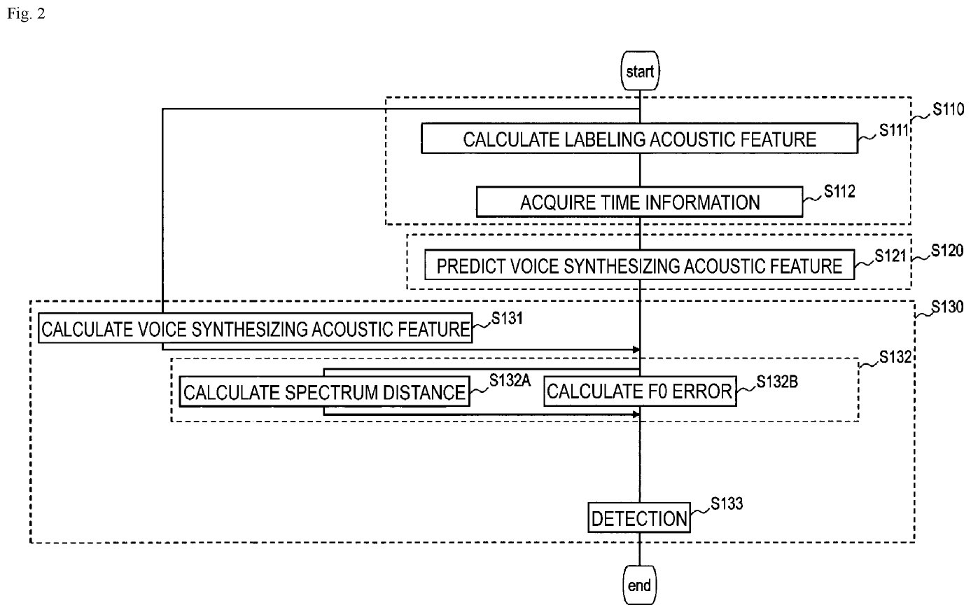

FIG. 1 is a functional block diagram of a detection device according to the present embodiment, and FIG. 2 illustrates a flowchart of processing thereof.

The detection device includes an automatic labeling unit 110, a voice synthesis unit 120, and a labeling error detection unit 130.

With voice data for learning, and a phoneme label corresponding to the voice data for learning to which no time information is added (hereinafter also referred to as “label without time information”) as inputs, the detection device performs automatic labeling of adding time information to the phoneme label, detects a labeling error included in a result of the automatic labeling, and outputs a detection result. In the present embodiment, information representing that it is a label with time information that requires manual addition of time information, or information representing that it is a label with time information that requires no manual addition of time information is output as a detection result. In other words, the label with time information that requires manual addition of time information is a label with time information including a labeling error, and the label with time information that requires no manual addition of time information is a label with time information including no labeling error. Note that it is desirable that the detection result be output in a unit appropriate for manual addition of time information. For example, the detection result is output in a unit of speech, sentence, or predetermined time.

Unlike configurations of automatic labeling in the related art, the present embodiment additionally includes the voice synthesis unit 120 and the labeling error detection unit 130.

The result of the automatic labeling also includes an error fatal to voice synthesis. Thus, it is possible to predict a voice synthesizing acoustic feature that is obtained when voice synthesis is performed at the voice synthesis unit 120 from a label with time information acquired at the automatic labeling unit 110 and to detect voice data including a labeling error from a view point of voice synthesis errors.

The detection device is, for example, a special device configured by loading a special program on a publicly known or dedicated computer including a central processing unit (CPU), a main storage device (random access memory (RAM)) and the like. The detection device executes each processing under the control of the central processing unit, for example. Data input to the detection device and data obtained through each processing are stored in, for example, the main storage device, and the data stored in the main storage device is read to the central processing unit as necessary and utilized for other processing. At least a part of each processing unit of the detection device may include hardware such as an integrated circuit. Each storage unit provided in the detection device may include a main storage device such as a random access memory (RAM), and middleware such as a relational database and a key-value store, for example. It should be noted that each storage unit does not necessarily be provided inside the detection device, and may be provided outside the detection device, being configured by an auxiliary storage device including a semiconductor memory element such as a hard disk, optical disk or flash memory.

Processing of each unit will be described below.

Automatic Labeling Unit 110

With voice data for learning and a label without time information as inputs, the automatic labeling unit 110 adds time information to the label without time information (S110), and outputs a label with time information.

For example, the automatic labeling unit 110 includes a labeling acoustic feature calculation unit 111 and a time information acquisition unit 112, and performs processing as follows.

Labeling Acoustic Feature Calculation Unit 111

With voice data for learning as an input, the labeling acoustic feature calculation unit 111 calculates a labeling acoustic feature from the voice data for learning (S111), and outputs the labeling acoustic feature. For example, the mel-frequency cepstrum coefficient (MFCC) and mel-filter bank representing the frequency characteristics of a voice are used for the labeling acoustic feature, but bottleneck features obtained from a DNN for voice recognition, other spectrograms, and the like may also be used. In short, it is only required that the labeling acoustic feature be an acoustic feature used for adding time information to a label with no time information at the time information acquisition unit 112 described later.

Time Information Acquisition Unit 112

With a label without time information and a labeling acoustic feature as inputs, the time information acquisition unit 112 acquires a phoneme label with time information (hereinafter also referred to as “label with time information”) corresponding to the voice data for learning from the label without time information and the labeling acoustic feature through the use of the labeling acoustic model, and then the time information acquisition unit 112 outputs the phoneme label (S112).

Note that the labeling acoustic model is an acoustic model receiving, as inputs, a label without time information and a labeling acoustic feature and outputting a label with time information, and is learned as follows, for example.

A labeling acoustic feature (hereinafter also referred to as “learning and labeling acoustic feature”) is calculated from voice data, and a phoneme label with time information (hereinafter also referred to as label with learning time information) to which the phoneme boundary of the voice data is clearly given is prepared. Note that this label with learning time information may be prepared by utilizing existing databases and the like, or may be manually prepared. The labeling acoustic model is learned by an existing acoustic model learning method using the learning and labeling acoustic feature and the label with learning time information, for example. For example, GMM-HMM and DNN-HMM may be used for the labeling acoustic model, and at the time information acquisition unit 112, the label with time information can be obtained through forced alignment with a Viterbi algorithm and the like. In addition, for the labeling acoustic model, Connectionist Temporal Classification (CTC) may also be utilized.

Voice Synthesis Unit 120

With a label with time information as an input, the voice synthesis unit 120 predicts a voice synthesizing acoustic feature that is obtained through voice synthesis from the label with time information (S120), and outputs a predicted value.

For example, the voice synthesis unit 120 includes a voice synthesizing acoustic feature prediction unit 121, and performs processing as follows.

Voice Synthesizing Acoustic Feature Prediction Unit 121

With a label with time information as an input, the voice synthesizing acoustic feature prediction unit 121 predicts the voice synthesizing acoustic feature corresponding to the label with time information through the use of the voice synthesizing acoustic model (S120), and acquires and outputs the predicted value. Note that the voice synthesizing acoustic model is a model receiving, as an input, a label with time information and outputting a voice synthesizing acoustic feature. For example, the voice synthesizing acoustic model learned as follows is utilized.

A voice synthesizing acoustic feature (hereinafter also referred to as learning voice synthesizing acoustic feature) is calculated from voice data, and a phoneme label with time information (hereinafter also referred to as label with learning voice synthesizing time information) to which the phoneme boundary of the voice data is clearly given is prepared. Note that this phoneme label with time information may be prepared by utilizing an existing database and the like, or may be manually prepared. The voice synthesizing acoustic model is learned by an existing acoustic model learning method using the learning voice synthesizing acoustic feature and the label with learning time information, for example.

For example, the voice synthesizing acoustic feature prediction unit 121 predicts a voice synthesizing acoustic feature of a voice with average speaker characteristics (average voice). In the case where the voice synthesizing acoustic model is a DNN or an HMM, a mel-cepstrum, a fundamental frequency (FO) or the like is used for the voice synthesizing acoustic feature, but an aperiodic index serving as an index of voice abrasiveness, a voiced/voiceless determination flag, or the like may be used.

Since the difference between the average voice and the voice data for learning is calculated at a difference calculation unit 132 in a later stage and labeling errors are detected based on the difference, it is desirable that the voice synthesizing acoustic model be one that can synthesize gender-dependent average voices.

Labeling Error Detection Unit 130

With voice data for learning and a predicted value as inputs, the labeling error detection unit 130 detects labeling errors from the acoustic difference (S130), and outputs the detection result.

For example, the labeling error detection unit 130 includes a voice synthesizing acoustic feature calculation unit 131, the difference calculation unit 132, and a detection unit 133. The difference calculation unit 132 includes an F0 error calculation unit 132A and a spectrum distance calculation unit 132B, and performs processing as follows.

Voice Synthesizing Acoustic Feature Calculation Unit 131 With voice data for learning as an input, the voice synthesizing acoustic feature calculation unit 131 calculates a voice synthesizing acoustic feature from the voice data for learning (S131), and outputs the voice synthesizing acoustic feature. As the voice synthesizing acoustic feature, it is only required to use the same acoustic feature as that predicted at the voice synthesizing acoustic feature prediction unit 121.

Difference Calculation Unit 132

With a voice synthesizing acoustic feature and a predicted value as inputs, the difference calculation unit 132 determines an acoustic difference (S132), and outputs the acoustic difference. For example, as an acoustic difference, at least one of an F0 error or a spectrum distance is utilized.

For example, the difference calculation unit 132 includes the F0 error calculation unit 132A and the spectrum distance calculation unit 132B, and performs the following processing.

FO Error Calculation Unit 132A With a voice synthesizing acoustic feature and a predicted value as inputs, the F0 error calculation unit 132A calculates the FO from each of the voice synthesizing acoustic feature and the predicted value, or acquires the FO included in the voice synthesizing acoustic feature and the predicted value. The F0 error calculation unit 132A calculates an error of the FO of the predicted value with respect to the FO of the voice synthesizing acoustic feature (hereinafter also referred to as F0 error) (S132A), and outputs the error. This error corresponds to the difference between the FO of voice synthesizing acoustic feature and the FO of the predicted value. For example, the F0 error is determined in a unit of frame.

Spectrum Distance Calculation Unit 132B

With a voice synthesizing acoustic feature and a predicted value as inputs, the spectrum distance calculation unit 132B calculates the spectrum distance from the voice synthesizing acoustic feature and the predicted value (S132B), and outputs the spectrum distance. The spectrum distance corresponds to the difference between the voice synthesizing acoustic feature and the predicted value. For example, the spectrum distance is determined in a unit of frame.

Detection Unit 133

With an acoustic difference as an input, the detection unit 133 detects a labeling error based on a relationship regarding which of the difference and a predetermined threshold value is larger or smaller than the other (S133), and outputs the detection result as an output value of the detection device. It is known that when the time information of the label with time information is wrong, a voice corresponding to a phoneme different from the voice synthesizing acoustic feature of the voice data for the learning is synthesized, and an acoustic difference (such as an F0 error and a spectrum distance) is increased at a frame near a position where a labeling error is present. In the present embodiment, labeling errors are detected by utilizing the above-described phenomenon.

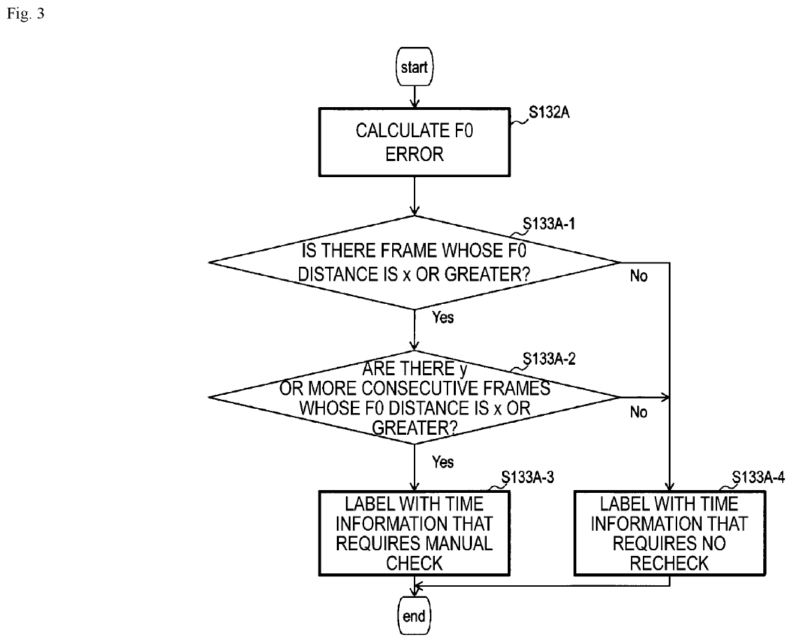

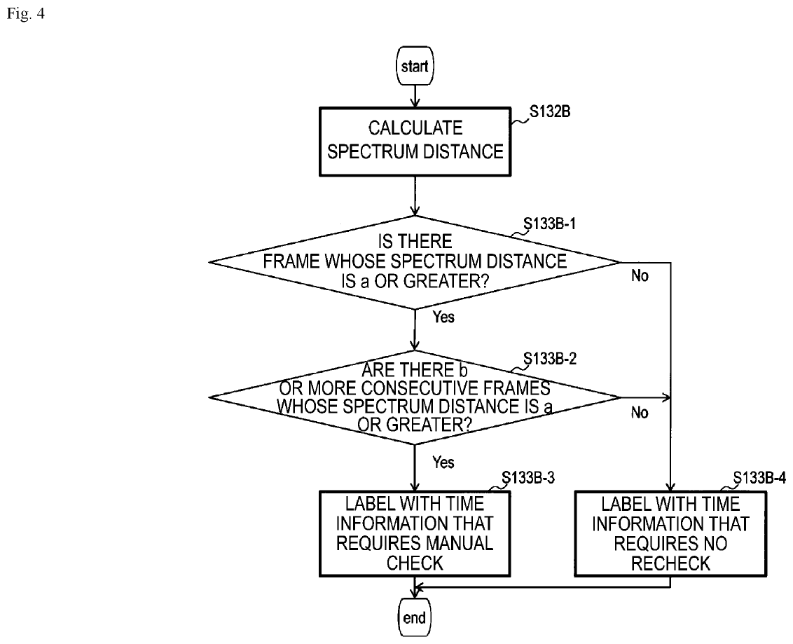

FIG. 3 illustrates an example of a flowchart of the detection unit 133 in the case where an FO error is utilized as an acoustic difference, and FIG. 4 illustrates an example of a flowchart of the detection unit 133 in the case where a spectrum distance is utilized as an acoustic difference. With such configurations, a determination regarding rhythm resulting from labeling errors is performed.

In the case where an F0 error is utilized as an acoustic difference, the F0 error is input to the detection unit 133 in a unit of frame, and the detection unit 133 first determines whether there is a frame whose F0 error is a threshold value x or greater (S133A-1 in FIG. 3). In the case where there is no such frame, it is determined that there is no labeling error, and the corresponding voice data is set as a label with time information that requires no manual addition of time information (S133A-4).

In the case where there is such a frame, whether the number of frames whose F0 error is the threshold value x or greater is not smaller than y is further determined (S133A-2). When the number of frames is smaller than y, it is recognized that even if a labeling error has occurred, the impact is small, and the corresponding voice data is set as a label with time information that requires no manual addition of time information (S133A-4). When the number of frames is y or greater, the corresponding voice data is set as a label with time information that requires manual addition of time information (S133A-3).

In the case where a spectrum distance is utilized as an acoustic difference, the spectrum distance is input to the detection unit 133 in a unit of frame, and the detection unit 133 first determines whether there is a frame whose spectrum distance is a threshold value a or greater (S133B-1 in FIG. 4). In the case where there is no such frame, it is determined that there is no labeling error, and the corresponding voice data is set as a label with time information that requires no manual addition of time information (S133B-4).

In the case where there is such a frame, whether the number of frames whose spectrum distance is the threshold value a or greater is not smaller than b is further determined (S133B-2). In the case where the number of frames is smaller than b, it is recognized that even if a labeling error has occurred, the impact is small, and the corresponding voice data is set as a label with time information that requires no manual addition of time information (S133B-4). In the case where the number of frames is b or greater, the corresponding voice data is set as a label with time information that requires manual addition of time information (S133B-3).

As an acoustic difference, the detection unit 133 may utilize one of the F0 error or the spectrum distance, or may utilize both of them for setting OR condition or AND condition to detect a label with time information that finally requires manual addition of time information.

In addition, in FIG. 3, by calculating the average and dispersion of the F0 errors and setting the threshold value x as average+a×standard deviation or greater, a frame with statistically obviously large errors can be detected. Also in FIG. 4, a threshold value y can be set by calculating the average and dispersion of the spectrum distances.

In addition, regarding the threshold values y and b, the number of frames of a case where an erroneous boundary of the phoneme is known to have a fatal influence on the voice synthesis is set.

Effects

With this configuration, erroneous automatic phoneme labeling can be automatically detected.

Modification

While a labeling error of a label with time information used for learning an acoustic model for voice synthesis is detected in the present embodiment, labeling errors of other applications may be detected. For example, a labeling error of a label with time information used for learning an acoustic model for voice recognition may also be detected.

### Second Embodiment

Differences from the first embodiment are mainly described below.

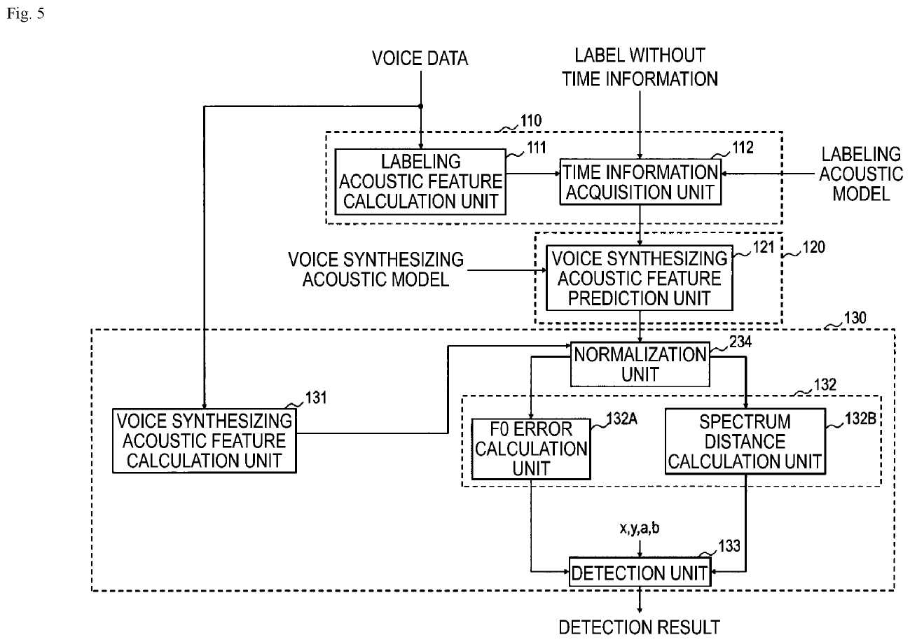

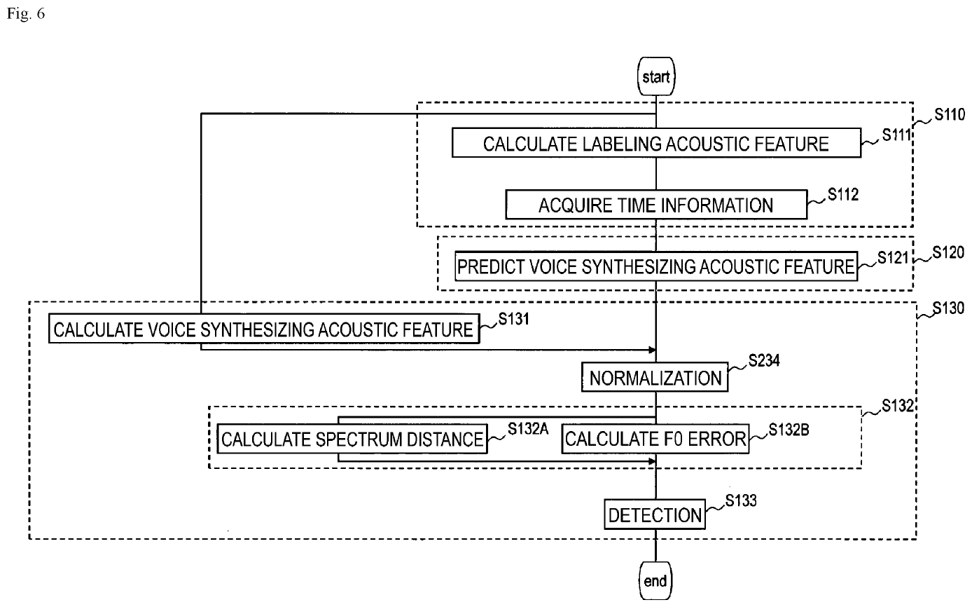

FIG. 5 is a functional block diagram of a detection device according to the present embodiment, and FIG. 6 illustrates a flowchart of processing thereof

The configuration of the labeling error detection unit 130 is different from that of the first embodiment.

The labeling error detection unit 130 includes the voice synthesizing acoustic feature calculation unit 131, the difference calculation unit 132, the detection unit 133, and further, a normalization unit 234.

In the first embodiment, some of the labeling target speakers have voices similar to the average voice obtained from the voice synthesis unit 120, and some of the labeling target speakers do not have, and thus it is necessary to set the threshold values a and x for each speaker at the labeling error detection unit 130. In the present configuration, the acoustic feature for voice synthesis is normalized in advance for each speaker, it is thus not necessary to set the threshold values a and x for each speaker.

The processing operations of the automatic labeling unit 110 and the voice synthesis unit 120 are the same as those of the first embodiment, and therefore only the labeling error detection unit 130 will be described below.

Normalization Unit 234

With a predicted value and a voice synthesizing acoustic feature as inputs, the normalization unit 234 of the labeling error detection unit 130 normalizes the predicted value and normalizes the voice synthesizing acoustic feature (S234), and outputs the normalized predicted value and voice synthesizing acoustic feature.

For example, the normalization unit 234 determines the average and dispersion of the inputs for each speaker, and normalizes the predicted value and voice synthesizing acoustic feature by the cepstrum mean-variance normalization method. For example, it is only required that the voice data input to the detection device be processed for each voice data from the same speaker and that the predicted value and voice synthesizing acoustic feature be normalized.

Further, at the difference calculation unit 132, the acoustic difference between the normalized voice synthesizing acoustic feature and the normalized predicted value is determined. For example, since the average and dispersion are normalized among speakers by inputting the normalized predicted value and voice synthesizing acoustic feature to the F0 error calculation unit 132A and the spectrum distance calculation unit 132B, it is not necessary to determine the threshold values a and x for determination for each speaker.

### Third Embodiment

Differences from the first embodiment are mainly described below.

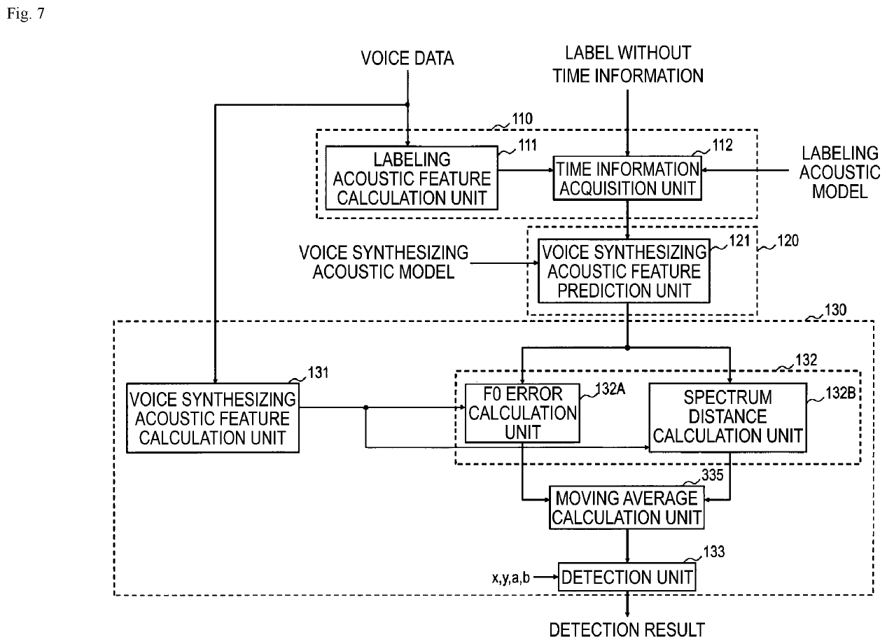

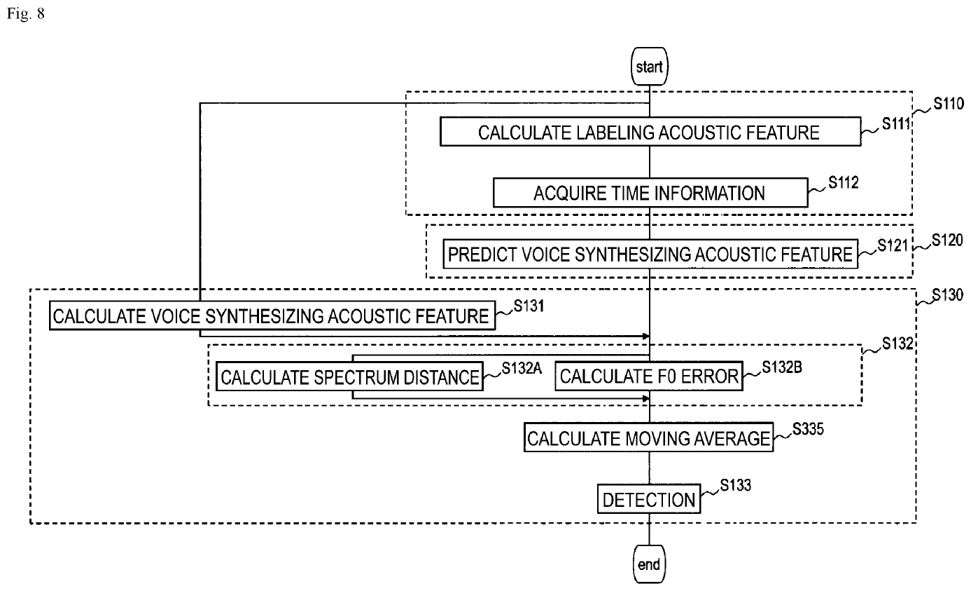

FIG. 7 is a functional block diagram of a detection device according to the present embodiment, and FIG. 8 illustrates a flowchart of processing thereof.

The configuration of the labeling error detection unit 130 is different from that of the first embodiment.

The labeling error detection unit 130 includes the voice synthesizing acoustic feature calculation unit 131, the difference calculation unit 132, the detection unit 133, and further, a moving average calculation unit 335.

With this configuration, the detection accuracy can be further increased at the labeling error detection unit 130. In the first embodiment, the determination is made based on the criterion that the number of frames whose F0 error is greater than the threshold value x is the threshold value y or greater, and that the number of frames whose spectrum distance is greater than the threshold value a is b or greater. However, in practice, even when the labeling error is large, the F0 error and/or spectrum distance may largely vary in each frame in a non-stationary manner and may not exceed the threshold values x and a consecutively. In such a case, labeling errors cannot be detected. In the present embodiment, the trajectory of the F0 error and/or spectrum distance that varies in a non-stationary manner is smoothed such that it can be easily detected by a detection using a threshold value.

The processing operations of the automatic labeling unit 110 and the voice synthesis unit 120 are the same as those of the first embodiment, and therefore only the labeling error detection unit 130 will be described below.

Moving Average Calculation Unit 335

With a difference that is an output value of the difference calculation unit 132 as an input, the moving average calculation unit 335 of the labeling error detection unit 130 calculates a moving average (S335), and outputs the moving average. For example, the difference is at least one of the F0 error or the spectrum distance, and the moving average corresponds to an averaging F0 error and an averaging spectrum distance with smooth trajectories.

With a moving average of an acoustic difference as an input, the detection unit 133 detects the labeling error on the basis of a relationship regarding which of the moving average of the difference and the predetermined threshold value is larger or smaller than the other (S133), and outputs the detection result as an output value of the detection device.

Unlike the first embodiment, through the use of at least one of the smoothly averaged F0 error or spectrum distance, the number of points that consecutively exceed the threshold value increases, making it easier to detect labeling errors.

### Modification Example

The present embodiment may be combined with the second embodiment, and can construct a detection device that does not require provision of the threshold value for each speaker while improving the continuity of the spectrum distance and the F0 error, which are the features for detection.

### Other Modifications

The present invention is not limited to the above embodiments and modifications. For example, the various processes described above may be executed not only in chronological order as described but also in parallel or on an individual basis as necessary or depending on the processing capabilities of the apparatuses that execute the processing. In addition, appropriate changes can be made without departing from the spirit of the present invention.

Program and Recording Medium

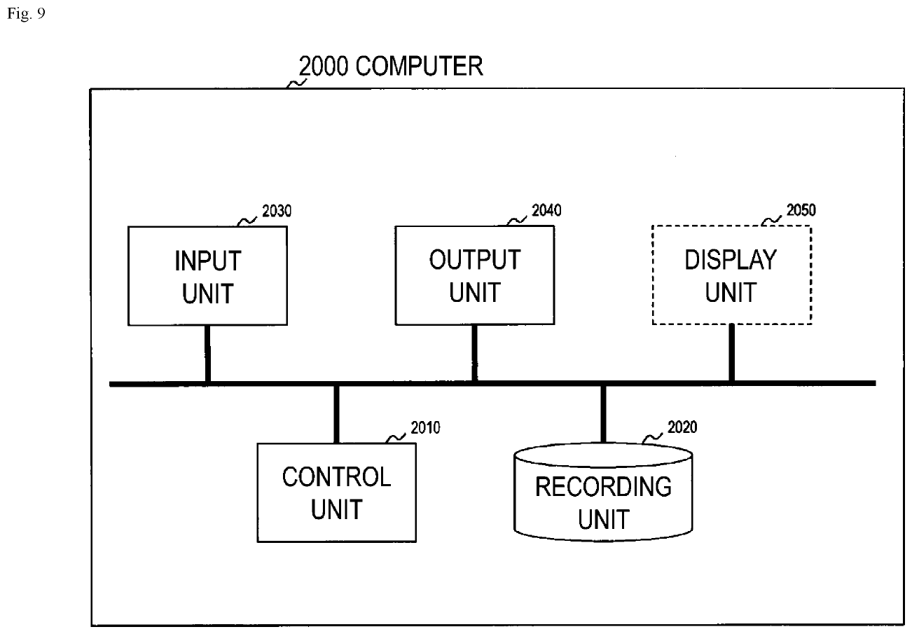

The above-described various processes can be implemented by reading programs for executing each step of the above-mentioned method in a recording unit 2020 of the computer illustrated in FIG. 9, and operating a control unit 2010, an input unit 2030, an output unit 2040 and the like.

The program in which the processing details are described can be recorded on a computer-readable recording medium. The computer-readable recording medium, for example, may be any type of medium such as a magnetic recording device, an optical disc, a magneto-optical recording medium, or a semiconductor memory.

In addition, the program is distributed, for example, by selling, transferring, or lending a portable recording medium such as a DVD or a CD-ROM with the program recorded on it. Further, the program may be stored in a storage device of a server computer and transmitted from the server computer to another computer via a network, so that the program is distributed.

For example, a computer executing the program first temporarily stores the program recorded on the portable recording medium or the program transmitted from the server computer in its own storage device. When the computer executes the process, the computer reads the program stored in the recording medium of the computer and executes a process according to the read program. Further, as another execution mode of this program, the computer may directly read the program from the portable recording medium and execute processing in accordance with the program, or, further, may sequentially execute the processing in accordance with the received program each time the program is transferred from the server computer to the computer. In addition, another configuration to execute the processing through a so-called application service provider (ASP) service in which processing functions are implemented just by issuing an instruction to execute the program and obtaining results without transmitting the program from the server computer to the computer may be employed. Further, the program in this mode is assumed to include information which is provided for processing of a computer and is equivalent to a program (data or the like that has characteristics of regulating processing of the computer rather than being a direct instruction to the computer).

In addition, although the device is configured by executing a predetermined program on a computer in this mode, at least a part of the processing details may be implemented by hardware.

1. A detection device comprising a processor configured to execute a method comprising:
calculating a labeling acoustic feature from voice data;
acquiring a label with time information corresponding to the voice data from a label with no time information corresponding to the voice data and the labeling acoustic feature through a use of a labeling acoustic model configured to receive, as inputs, a label with no time information and a labeling acoustic feature;
outputting a label with time information;
predicting an acoustic feature corresponding to the label with time information;
acquiring a predicted value through a use of an acoustic model configured to receive, as an input, a label with time information;
outputting an acoustic feature;
calculating an acoustic feature from the voice data;
determining an acoustic difference between the acoustic feature and the predicted value; and
detecting a labeling error on a basis of a relationship regarding which of the difference and a predetermined threshold value is larger or smaller than the other.

2. The detection device according to claim 1, wherein
the difference includes at least one of a difference in a fundamental frequency or a spectrum distance.

3. The detection device according to claim 1, the processor further configured to execute a method comprising:
normalizing the predicted value and normalize the acoustic feature, wherein
the determining further determines an acoustic difference between the acoustic feature that is normalized and the predicted value that is normalized.

4. The detection device according to claim 1, the processor further configured to execute a method comprising
calculating a moving average of the difference, wherein
the detecting further detects a labeling error on a basis of a relationship regarding which of the moving average of the difference and a predetermined threshold value is larger or smaller than the other.

5. A detection method comprising:
calculating a labeling acoustic feature from voice data;
acquiring a label with time information corresponding to the voice data from a label with no time information corresponding to the voice data and the labeling acoustic feature through a use of a labeling acoustic model configured to receive, as inputs, a label with no time information and a labeling acoustic feature,
outputting a label with time information;
predicting an acoustic feature corresponding to the label with time information,
acquiring a predicted value through a use of an acoustic model configured to receive, as an input, a label with time information,
outputting an acoustic feature;
calculating an acoustic feature from the voice data;
determining an acoustic difference between the acoustic feature and the predicted value; and
detecting a labeling error on a basis of a relationship regarding which of the difference and a predetermined threshold value is larger or smaller than the other.

6. The detection method according to claim 5, further comprising:
normalizing the predicted value the acoustic feature, wherein
the determining of the acoustic difference further includes determining an acoustic difference between the acoustic feature that is normalized and the predicted value that is normalized is determined.

7. The detection method according to claim 5, the processor further configured to execute a method comprising
calculating a moving average of the difference, wherein
in the detecting, a labeling error is detected on a basis of a relationship regarding which of the moving average of the difference and a predetermined threshold value is larger or smaller than the other.

8. A computer-readable non-transitory recording medium storing computer-executable program instructions that when executed by a processor cause a computer to execute a method comprising:
calculating a labeling acoustic feature from voice data;
acquiring a label with time information corresponding to the voice data from a label with no time information corresponding to the voice data and the labeling acoustic feature through a use of a labeling acoustic model configured to receive, as inputs, a label with no time information and a labeling acoustic feature;
outputting a label with time information;
predicting an acoustic feature corresponding to the label with time information;
acquiring a predicted value through a use of an acoustic model configured to receive, as an input, a label with time information;
outputting an acoustic feature;
calculating an acoustic feature from the voice data;
determining an acoustic difference between the acoustic feature and the predicted value; and
detecting a labeling error on a basis of a relationship regarding which of the difference and a predetermined threshold value is larger or smaller than the other.

9. The detection device according to claim 2, the processor further configured to execute a method comprising:
normalizing the predicted value and the acoustic feature, wherein
the determining further determines an acoustic difference between the acoustic feature that is normalized and the predicted value that is normalized.

10. The detection device according to claim 2, the processor further configured to execute a method comprising:
calculating a moving average of the difference, wherein
the detecting further detects a labeling error on a basis of a relationship regarding which of the moving average of the difference and a predetermined threshold value is larger or smaller than the other.

11. The detection method according to claim 5, wherein
the difference includes at least one of a difference in a fundamental frequency or a spectrum distance.

12. The detection method according to claim 6, the method further comprising:
calculating a moving average of the difference, wherein
the detecting further detects a labeling error on a basis of a relationship regarding which of the moving average of the difference and a predetermined threshold value is larger or smaller than the other.

13. The detection method according to claim 11, the method further comprising:
calculating a moving average of the difference, wherein
the detecting further detects a labeling error on a basis of a relationship regarding which of the moving average of the difference and a predetermined threshold value is larger or smaller than the other.

14. The computer-readable non-transitory recording medium according to claim 8, wherein
the difference includes at least one of a difference in a fundamental frequency or a spectrum distance.

15. The computer-readable non-transitory recording medium according to claim 8, the processor further configured to execute a method comprising:
normalizing the predicted value and the acoustic feature, wherein
the determining further determines an acoustic difference between the acoustic feature that is normalized and the predicted value that is normalized.

16. The computer-readable non-transitory recording medium according to claim 8, the processor further configured to execute a method comprising
calculating a moving average of the difference, wherein
the detecting further detects a labeling error on a basis of a relationship regarding which of the moving average of the difference and a predetermined threshold value is larger or smaller than the other.

17. The computer-readable non-transitory recording medium according to claim 14, the processor further configured to execute a method comprising:
normalizing the predicted value and the acoustic feature, wherein
the determining further determines an acoustic difference between the acoustic feature that is normalized and the predicted value that is normalized.

18. The computer-readable non-transitory recording medium according to claim 14, the processor further configured to execute a method comprising
calculating a moving average of the difference, wherein
the detecting further detects a labeling error on a basis of a relationship regarding which of the moving average of the difference and a predetermined threshold value is larger or smaller than the other.

19. The computer-readable non-transitory recording medium according to claim 15, the processor further configured to execute a method comprising
calculating a moving average of the difference, wherein
the detecting further detects a labeling error on a basis of a relationship regarding which of the moving average of the difference and a predetermined threshold value is larger or smaller than the other.
